(19) United States
(12) Patent Application Publication
(10) Pub. No.: US 2021/0117977 A1
(43) Pub. Date: Apr. 22, 2021

(54) PARALLEL MACHINE LEARNING MODELS

(71) Applicant: AT&T Intellectual Property I, L.P., Atlanta, GA (US)

(72) Inventors: Christopher Kim, Plano, TX (US); Mohammad Omar Khalid Mirza, Plano, TX (US); Eric Noble, Quartz Hill, CA (US)

(21) Appl. No.: 16/655,390

(22) Filed: Oct. 17, 2019

(51) Int. Cl. G06Q 20/40; G06N 20/20; G06K 9/62; G06F 17/15

(52) U.S. Cl. CPC G06Q 20/4016; G06F 17/15; G06K 9/6256; G06N 20/20

(57) ABSTRACT

A processing system including at least one processor may obtain at least one of a first machine learning model or a second machine learning model, deploy the at least one of the first machine learning model or the second machine learning model to a plurality of trained machine learning models for operating in parallel with respect to a same prediction task, obtain at least one data set, apply the at least one data set to the plurality of trained machine learning models, obtain the first result of the first machine learning model and a second result of the second machine learning model in accordance with the applying, store the first result of the first machine learning model and the second result of the second machine learning model, and provide an output in accordance with at least one of the first result or the second result.

The present disclosure relates generally to machine learning model deployment, and more particularly to methods, computer-readable media, and apparatuses for providing selected results from an application of at least one data set to a plurality of trained machine learning models.

### BACKGROUND

Machine learning in computer science is the scientific study and process of creating algorithms based on data that perform a task without any instructions. These algorithms are called models and different types of models can be created based on the type of data that the model takes as input and also based on the type of task (prediction, classification, clustering) that the model is trying to accomplish. The general approach to machine learning involves using the training data to create the model, testing the model using the cross-validation and testing data, and then deploying the model to production to be used by real-world applications

### SUMMARY

In one example, the present disclosure describes a method, computer-readable medium, and apparatus for providing selected results from an application of at least one data set to a plurality of trained machine learning models. For instance, in one example, a processing system including at least one processor may obtain at least one of a first machine learning model or a second machine learning model and deploy the at least one of the first machine learning model or the second machine learning model to a plurality of trained machine learning models for operating in parallel with respect to a same prediction task, wherein the plurality of trained machine learning models includes at least the first machine learning model and the second machine learning model, wherein the same prediction task comprises generating at least a first result of the first machine learning model and a second result of the second machine learning model in accordance with at least one data set. The processing system may further obtain the at least one data set, apply the at least one data set to the plurality of trained machine learning models, obtain the first result of the first machine learning model and a second result of the second machine learning model in accordance with the applying, store the first result of the first machine learning model and the second result of the second machine learning model, and provide an output in accordance with at least one of the first result or the second result.

### BRIEF DESCRIPTION OF THE DRAWINGS

The present disclosure can be readily understood by considering the following detailed description in conjunction with the accompanying drawings, in which:

FIG. 1 illustrates one example of a system related to the present disclosure;

FIG. 2 illustrates an example process for providing selected results from an application of at least one data set to a plurality of trained machine learning models;

FIG. 3 illustrates a flowchart of an example method for providing selected results from an application of at least one data set to a plurality of trained machine learning models; and

FIG. 4 illustrates a high-level block diagram of a computing device specially programmed to perform the functions described herein.

To facilitate understanding, identical reference numerals have been used, where possible, to designate identical elements that are common to the figures.

### DETAILED DESCRIPTION

The present disclosure broadly discloses methods, non-transitory (i.e., tangible or physical) computer-readable storage media, and apparatuses for providing selected results from an application of at least one data set to a plurality of trained machine learning models.

Examples of the present disclosure provide for the use of multiple machine learning models (MLMs) in parallel, while enabling users to decide which model to use based on results from these multiple MLMs. In a typical machine learning (ML) pipeline, different MLMs are analyzed using training data and the best performing model is selected. In general, the accuracy or performance of a model depends on the data used to train the model. To illustrate, a machine learning prediction flow may involve: (1) retrieving data from a database, e.g., a non-Structured Query Language (SQL)-based database, such as MongoDB, a SQL-based database, etc. In many cases, the data obtained may be noisy and need to be preprocessed; (2) converting data types, e.g., manipulating the data into appropriate form(s) to permit feature engineering to be applied to the data; (3) feature engineering—a process of manipulating the data retrieved from the database, which may involve removing or adding attributes, normalizing attribute data to a similar scale, etc.; (4) prediction, e.g., feeding the processed data to the MLM and acquiring results; (5) constructing a response—the form of the output may depend on the type of the ML task for which the MLM is adapted, as well as the type of response expected by a consuming application.

As referred to herein, a machine learning model (MLM) (or machine learning-based model) may comprise a machine learning algorithm (MLA) that has been “trained” or configured in accordance with input data (e.g., training data) to perform a particular service. As also referred to herein an MLM may refer to an untrained MLM (e.g., an MLA that is ready to be trained in accordance with appropriately formatted data). Examples of the present disclosure are not limited to any particular type of MLA/model, but are broadly applicable to various types of MLAs/models that utilize training data, such as support vector machines (SVMs), e.g., linear or non-linear binary classifiers, multi-class classifiers, deep learning algorithms/models, decision tree algorithms/models, e.g., a decision tree classifier, k-nearest neighbor (KNN) clustering algorithms/models, a gradient boosted or gradient descent algorithm/model, such as an XGBoost-based model, and so forth.

In many cases, the run-time data input to a model may vary when compared to the training data used to develop the model. For such models to maintain a high accuracy, it may be desirable to retrain the models again with appropriate data. Thus, the MLM training process starts over again. Such infrastructure may expect a single model to perform well with different types of input data. In addition, replacing these singular models may involve multiple repetitions of initiating the model training and testing process.

Examples of the present disclosure run multiple models in parallel, with each model receiving the same run-time data. These models perform different computations on the data and provide their results. In one example, one of the models may be selected as the “primary” or “active” model from which the results/output of the MLM are used for final evaluation and/or output. However, the results from all of the models may be stored in a database, which can be used to analyze and compare the different models based on the type of input data, thus providing additional insights on model selection decisions.

Different models may be selected to run in parallel based on the type of input data parameters. Different models may alternatively or additionally be selected to run in parallel for a given task based on the performance of various different models being given the same input data. With different models, each model is tuned differently and has a different set of parameters. Accordingly, these various models may be run in parallel with the same input data to provide a broad view of how different models perform with that type of data. The present disclosure also supports running multiple versions of the same model with different parameters (which may also be conceptualized as different, unique models). This enables analysis and dynamic selection of model parameters while the models are in use and deployed in a production environment.

Additionally, the present disclosure supports running multiple models with different data inputs. In this way, the performance changes resulting from the adding of new data or performing additional data manipulation can be determined and taken into consideration in selecting a primary MLM. As noted above, the results from all of the MLM running in parallel may be stored in a database. Using this database, the different models' results may be compared in order to select a primary MLM, to select which MLMs should be maintained in operation (e.g., in parallel for the requisite computing task), to select the parameters for a given model, and also to select the type(s) of data and/or the data source(s) to feed to the respective models.

A primary model can be selected based on different variables. For instance, in one example, a user, such as a system administrator, a data scientist, a network engineer, etc. may view results of the various parallel-running MLMs to select a primary MLM from which the results may be used as an output. For example, a user may consider the type of prediction task and the results that are observed with the current models to select a primary MLM. For instance, the user may select the best performing MLM (e.g., in terms of the accuracy of prediction), or may select a good performing MLM that has a lower cost of deployment, a faster processing time, less processor and memory usage, etc. (e.g., as compared to the best performing/most accurate MLM). The dynamic changing of the primary model may provide better results by allowing for the selection of a preferred model under changing scenarios. For example, in other machine learning processes, changing a model may require training and re-deployment, which may be time consuming. In contrast, a user input-based model switching in real-time removes the time overhead with switching to a new model.

Alternatively, or in addition, a primary model may be selected automatically based upon statistics such as AUC (area under ROC (receiver operating characteristic) curve) score, mean squared error or root mean squared error, etc. With multiple models being trained and evaluated, the best performing model could be selected based on these statistics. In one example, multiple factors may be weighted to generate a combined score, such as the AUC score and/or the mean squared error, plus one or more of a cost of use, an average computation time, a processor utilization, a memory utilization, etc., or any other combination of such factors, or different factors of the same or a similar nature.

In one example, the present disclosure enables the selection of a correlation of the outputs of multiple models to create a new set of results. For instance, the multiple models' results may provide different types of insights based on the nature of each model, the type(s) of data that each model is trained with and operates on, and so forth. For instance, a combined result set may be based upon weighted results/outputs from two or more of the parallel MLMs. In one example, the present disclosure also provides for correlation between model results to provide a confidence score of the prediction(s). For instance, the results/outputs of one or more additional MLMs operating in parallel may be used to generate a confidence score of the result/output of a primary MLM. In one example, if the correlation between the results/outputs of the multiple MLMs is low (e.g., below a threshold percentage or level of correlation), then an aggregate result or a different model's result may be selected as a final output (e.g., instead of the result/output of the primary MLM). In one example, a correlation metric between MLMs may also be used to provide a combined result from complementary models which use different input data sets.

Examples of the present disclosure not only allow for model comparison, but can also be utilized to compare and select among available datasets. For instance, MLMs may trend towards better performance when there is an increase in the data or when a new dataset with additional features is used. In many cases, adding features to an existing dataset could involve joining two datasets to create a larger dataset. However, before the new dataset is joined with the existing dataset, it may need to be mined and preprocessed, which is often time consuming and without guarantee that the new added features in the dataset would lead to significantly better results. Additionally, acquiring the new dataset may be costly, again without any guarantee of improvement. However, in these circumstances, examples of the present disclosure allow for multiple MLM to be run, e.g., one or more with the existing dataset and one or more with the new dataset (where the new dataset may be partially overlapping with the existing dataset, or may be non-overlapping). The results from the various models may then be compared to determine whether the new dataset accounted for any improvements in accuracy. In addition, the results allow for the best dataset(s) and model combination to be chosen as a primary MLM and/or for a best or preferred set of MLMs to be used in a combination to generate a composite result. As such, an operator is enabled to make data driven decisions as to whether new third-party data should be adopted for long term use based on the performance of the model(s) with new data and current data, respectively.

In one example, the present disclosure may include an artificial intelligence (AI) component to learn based upon the user selections (e.g., of primary MLMs) that were made in accordance with different input data sets. The AI component may then make real-time selections of primary MLMs (and/or combinations of MLMs for composite results) based upon the learned user preferences. In one example, the AI component may make the real-time selections on an ongoing basis, e.g., unless a user makes a manual selection, in which case the user selection may override the AI component, and the AI component may incorporate the additional user selection into the learning process. Notably, with vast and different types of data sets being available, it may be difficult for a human to select a model for each different circumstance. In this scenario, the AI component that is capable of detecting more intricate patterns in the available data may be better positioned to adapt to changing data patterns, thereby helping to ensure accuracy and scalability. In addition, the present examples may be used in an unsupervised machine learning environment where the final truth sets are unknown.

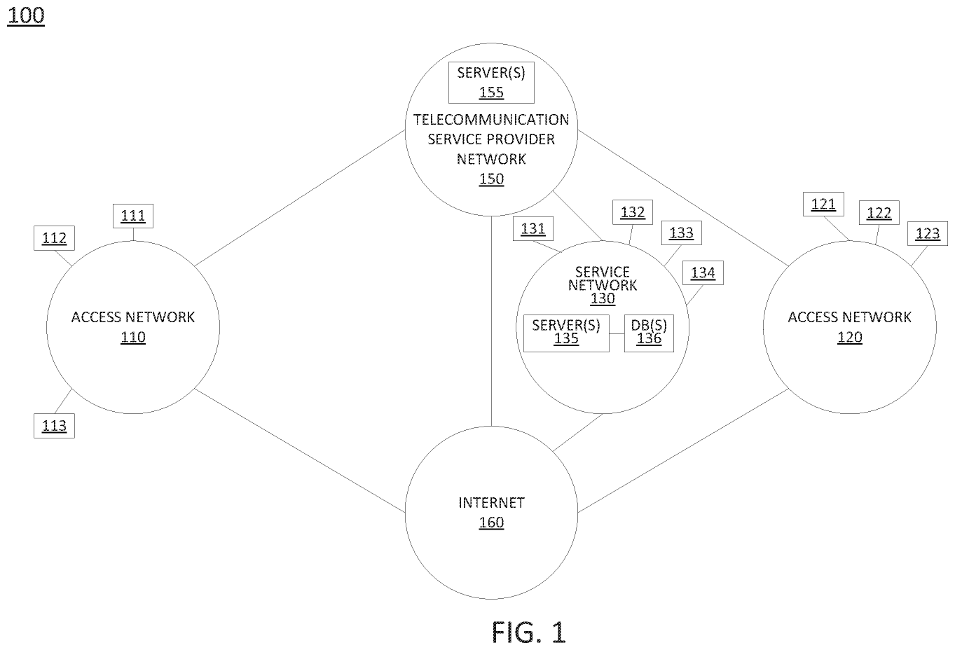

Thus, examples of the present disclosure allow for multiple models to be run in parallel for greater data utilization and to learn more meaningful and deeper insights not only about the data being used but also about the various models. The model and data insights help in manual or automated selection of the best model(s) and/or data set(s)/data feed(s). Examples of the present disclosure may also be further enhanced by fusing the architecture with an artificial intelligence (AI) learning component to provide additional learning and insights. These and other aspects of the present disclosure are discussed in greater detail below in connection with the examples of FIGS. 1-4.

To aid in understanding the present disclosure, FIG. 1 illustrates an example system 100 comprising a plurality of different networks in which examples of the present disclosure may operate. Telecommunication service provider network 150 may comprise a core network with components for telephone services, Internet services, and/or television services (e.g., triple-play services, etc.) that are provided to customers (broadly “subscribers”), and to peer networks. In one example, telecommunication service provider network 150 may combine core network components of a cellular network with components of a triple-play service network. For example, telecommunication service provider network 150 may functionally comprise a fixed-mobile convergence (FMC) network, e.g., an IP Multimedia Subsystem (IMS) network. In addition, telecommunication service provider network 150 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Telecommunication service provider network 150 may also further comprise a broadcast television network, e.g., a traditional cable provider network or an Internet Protocol Television (IPTV) network, as well as an Internet Service Provider (ISP) network. With respect to television service provider functions, telecommunication service provider network 150 may include one or more television servers for the delivery of television content, e.g., a broadcast server, a cable head-end, a video-on-demand (VoD) server, and so forth. For example, telecommunication service provider network 150 may comprise a video super hub office, a video hub office and/or a service office/central office.

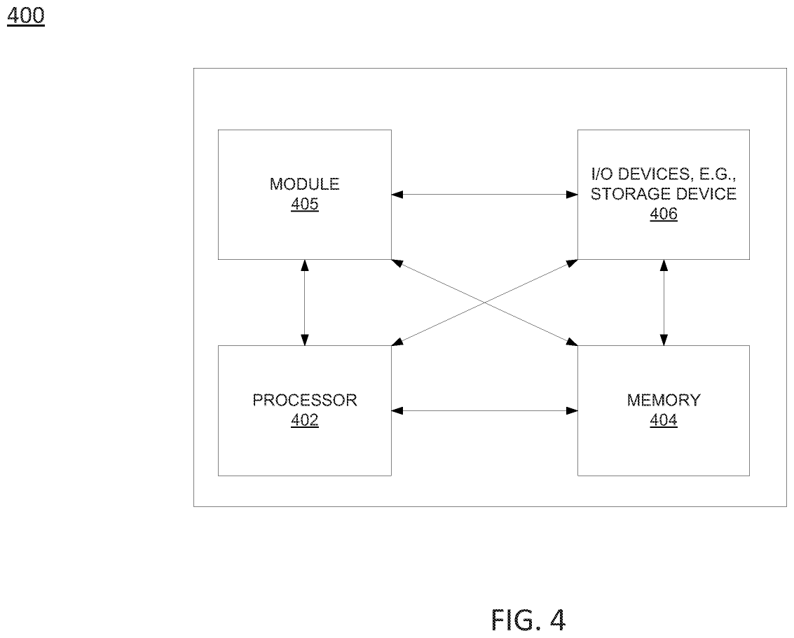

In one example, telecommunication service provider network 150 may also include one or more servers 155. In one example, the servers 155 may each comprise a computing device or system, such as computing system 400 depicted in FIG. 4, and may be configured to host one or more centralized system components. For example, a first centralized system component may comprise a database of assigned telephone numbers, a second centralized system component may comprise a database of basic customer account information for all or a portion of the customers/subscribers of the telecommunication service provider network 150, a third centralized system component may comprise a cellular network service home location register (HLR), e.g., with current serving base station information of various subscribers, and so forth. Other centralized system components may include a Simple Network Management Protocol (SNMP) trap, or the like, a billing system, a customer relationship management (CRM) system, a trouble ticket system, an inventory system (IS), an ordering system, an enterprise reporting system (ERS), an account object (AO) database system, and so forth. In addition, other centralized system components may include, for example, a layer 3 router, a short message service (SMS) server, a voicemail server, a video-on-demand server, a server for network traffic analysis, and so forth. It should be noted that in one example, a centralized system component may be hosted on a single server, while in another example, a centralized system component may be hosted on multiple servers, e.g., in a distributed manner. For ease of illustration, various components of telecommunication service provider network 150 are omitted from FIG. 1.

In one example, access networks 110 and 120 may each comprise a Digital Subscriber Line (DSL) network, a broadband cable access network, a Local Area Network (LAN), a cellular or wireless access network, and the like. For example, access networks 110 and 120 may transmit and receive communications between endpoint devices 111-113, endpoint devices 121-123, and service network 130, and between telecommunication service provider network 150 and endpoint devices 111-113 and 121-123 relating to voice telephone calls, communications with web servers via the Internet 160, and so forth. Access networks 110 and 120 may also transmit and receive communications between endpoint devices 111-113, 121-123 and other networks and devices via Internet 160. For example, one or both of the access networks 110 and 120 may comprise an ISP network, such that endpoint devices 111-113 and/or 121-123 may communicate over the Internet 160, without involvement of the telecommunication service provider network 150. Endpoint devices 111-113 and 121-123 may each comprise a telephone, e.g., for analog or digital telephony, a mobile device, such as a cellular smart phone, a laptop, a tablet computer, etc., a router, a gateway, a desktop computer, a plurality or cluster of such devices, a television (TV), e.g., a “smart” TV, a set-top box (STB), and the like. In one example, any one or more of endpoint devices 111-113 and 121-123 may represent one or more user devices and/or one or more servers of one or more data set owners or providers, such as a weather data service, a traffic management service (such as a state or local transportation authority, a toll collection service, etc.), a payment processing service (e.g., a credit card company, a retailer, etc.), a police, fire, or emergency medical service, and so on.

In one example, the access networks 110 and 120 may be different types of access networks. In another example, the access networks 110 and 120 may be the same type of access network. In one example, one or more of the access networks 110 and 120 may be operated by the same or a different service provider from a service provider operating the telecommunication service provider network 150. For example, each of the access networks 110 and 120 may comprise an Internet service provider (ISP) network, a cable access network, and so forth. In another example, each of the access networks 110 and 120 may comprise a cellular access network, implementing such technologies as: global system for mobile communication (GSM), e.g., a base station subsystem (BSS), GSM enhanced data rates for global evolution (EDGE) radio access network (GERAN), or a UMTS terrestrial radio access network (UTRAN) network, among others, where telecommunication service provider network 150 may provide service network 130 functions, e.g., of a public land mobile network (PLMN)-universal mobile telecommunications system (UMTS)/General Packet Radio Service (GPRS) core network, or the like. In still another example, access networks 110 and 120 may each comprise a home network or enterprise network, which may include a gateway to receive data associated with different types of media, e.g., television, phone, and Internet, and to separate these communications for the appropriate devices. For example, data communications, e.g., Internet Protocol (IP) based communications may be sent to and received from a router in one of the access networks 110 or 120, which receives data from and sends data to the endpoint devices 111-113 and 121-123, respectively.

In this regard, it should be noted that in some examples, endpoint devices 111-113 and 121-123 may connect to access networks 110 and 120 via one or more intermediate devices, such as a home gateway and router, an Internet Protocol private branch exchange (IPPBX), and so forth, e.g., where access networks 110 and 120 comprise cellular access networks, ISPs and the like, while in another example, endpoint devices 111-113 and 121-123 may connect directly to access networks 110 and 120, e.g., where access networks 110 and 120 may comprise local area networks (LANs), enterprise networks, and/or home networks, and the like.

In one example, the service network 130 may comprise a local area network (LAN), or a distributed network connected through permanent virtual circuits (PVCs), virtual private networks (VPNs), and the like for providing data and voice communications. In one example, the service network 130 may be associated with the telecommunication service provider network 150. For example, the service network 130 may comprise one or more devices for providing services to subscribers, customers, and/or users. For example, telecommunication service provider network 150 may provide a cloud storage service, web server hosting, and other services. As such, service network 130 may represent aspects of telecommunication service provider network 150 where infrastructure for supporting such services may be deployed. In another example, service network 130 may represent a third-party network, e.g., a network of an entity that provides a service for providing selected results from an application of at least one data set to a plurality of trained machine learning models, in accordance with the present disclosure.

In one example, the service network 130 links one or more devices 131-134 with each other and with Internet 160, telecommunication service provider network 150, devices accessible via such other networks, such as endpoint devices 111-113 and 121-123, and so forth. In one example, devices 131-134 may each comprise a telephone for analog or digital telephony, a mobile device, a cellular smart phone, a laptop, a tablet computer, a desktop computer, a bank or cluster of such devices, and the like. In an example where the service network 130 is associated with the telecommunication service provider network 150, devices 131-134 of the service network 130 may comprise devices of network personnel, such as customer service agents, sales agents, marketing personnel, or other employees or representatives who are tasked with addressing customer-facing issues and/or personnel for network maintenance, network repair, construction planning, and so forth.

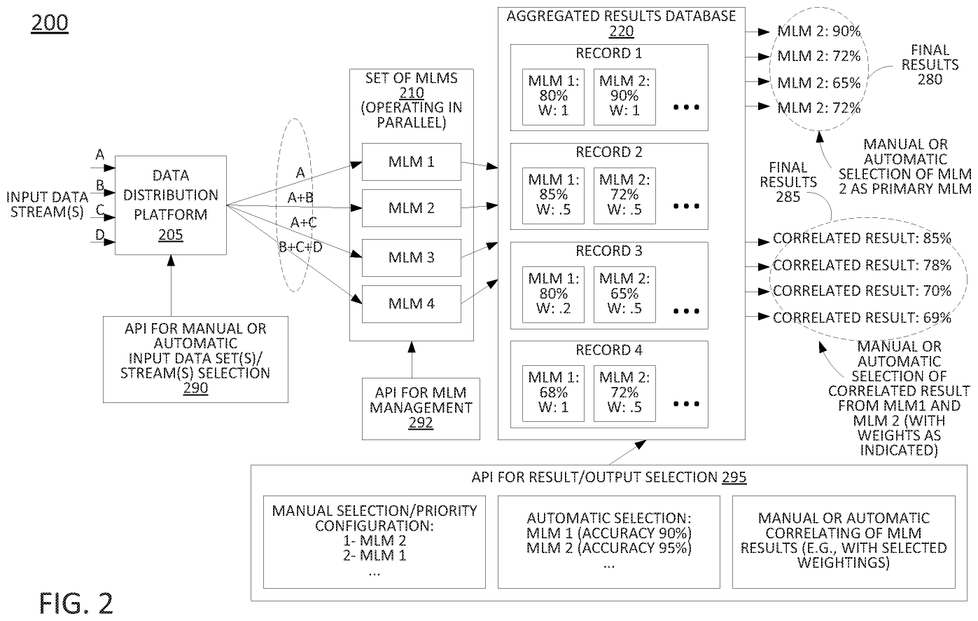

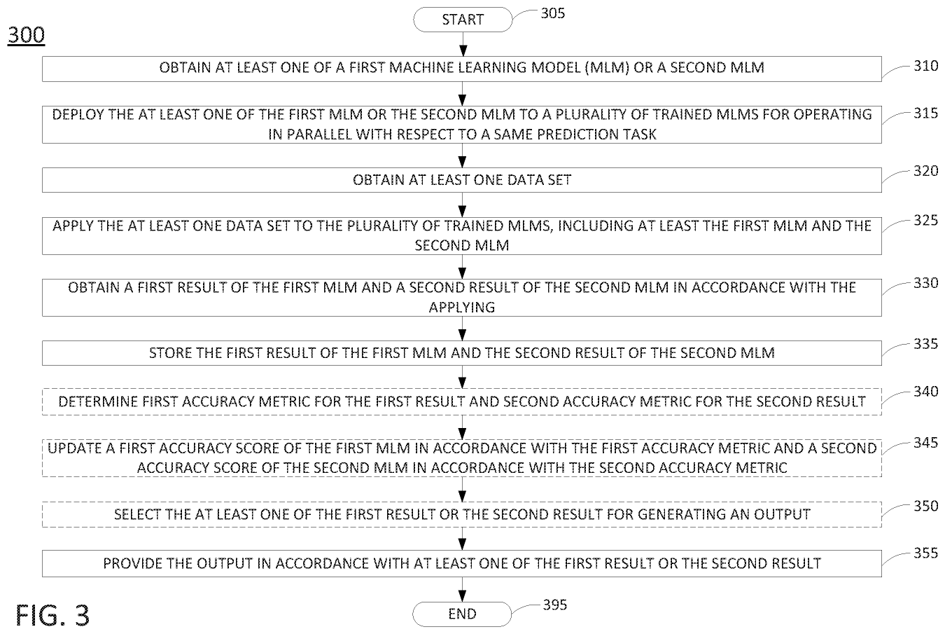

In the example of FIG. 1, service network 130 may include one or more servers 135 which may each comprise all or a portion of a computing device or processing system, such as computing system 400, and/or a hardware processor element 402 as described in connection with FIG. 4 below, specifically configured to perform various steps, functions, and/or operations for providing selected results from an application of at least one data set to a plurality of trained machine learning models, as described herein. For example, one of the server(s) 135, or a plurality of servers 135 collectively, may perform operations in connection with the example process 200 of FIG. 2 and/or the example method 300 of FIG. 3, or as otherwise described herein. In one example, the one or more of the servers 135 may comprise an MLM-based service platform (e.g., a network-based and/or cloud-based service hosted on the hardware of servers 135).

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device, or computing system, including one or more processors, or cores (e.g., as illustrated in FIG. 4 and discussed below) or multiple computing devices collectively configured to perform various steps, functions, and/or operations in accordance with the present disclosure.

In one example, service network 130 may also include one or more databases (DBs) 136, e.g., physical storage devices integrated with server(s) 135 (e.g., database servers), attached or coupled to the server(s) 135, and/or in remote communication with server(s) 135 to store various types of information in support of systems for providing selected results from an application of at least one data set to a plurality of trained machine learning models, as described herein. As just one example, DB(s) 136 may be configured to receive and store network operational data collected from the telecommunication service provider network 150, such as call logs, mobile device location data, control plane signaling and/or session management messages, data traffic volume records, call detail records (CDRs), error reports, network impairment records, performance logs, alarm data, and other information and statistics, which may then be compiled and processed, e.g., normalized, transformed, tagged, etc., and forwarded to DB(s) 136, via one or more of the servers 135.

In one example, DB(s) 136 may be configured to receive and store records from customer, user, and/or subscriber interactions, e.g., with customer facing automated systems and/or personnel of a telecommunication network service provider or other entity associated with the service network 130. For instance, DB(s) 136 may maintain call logs and information relating to customer communications which may be handled by customer agents via one or more of the devices 131-134. For instance, the communications may comprise voice calls, online chats, etc., and may be received by customer agents at devices 131-134 from one or more of devices 111-113, 121-123, etc. The records may include the times of such communications, the start and end times and/or durations of such communications, the touchpoints traversed in a customer service flow, results of customer surveys following such communications, any items or services purchased, the number of communications from each user, the type(s) of device(s) from which such communications are initiated, the phone number(s), IP address(es), etc. associated with the customer communications, the issue or issues for which each communication was made, etc.

Alternatively, or in addition, any one or more of devices 131-134 may comprise an interactive voice response system (IVR) system, a web server providing automated customer service functions to subscribers, etc. In such case, DB(s) 136 may similarly maintain records of customer, user, and/or subscriber interactions with such automated systems. The records may be of the same or a similar nature as any records that may be stored regarding communications that are handled by a live agent. Similarly, any one or more of devices 131-134 may comprise a device deployed at a retail location that may service live/in-person customers. In such case, the one or more of devices 131-134 may generate records that may be forwarded and stored by DB(s) 136. The records may comprise purchase data, information entered by employees regarding inventory, customer interactions, surveys responses, the nature of customer visits, etc., coupons, promotions, or discounts utilized, and so forth. In still another example, any one or more of devices 111-113 or 121-123 may comprise a device deployed at a retail location that may service live/in-person customers and that may generate and forward customer interaction records to DB(s) 136.

In one example, DB(s) 136 may alternatively or additionally receive and store data from one or more external data feeds. For instance, DB(s) 136 may receive and store weather data from a device of a third-party, e.g., a weather service, a traffic management service, etc. via one of access networks 110 or 120. To illustrate, one of endpoint devices 111-113 or 121-123 may represent a weather data server (WDS). In one example, the weather data may be received via a weather service data feed, e.g., an NWS extensible markup language (XML) data feed, or the like. In another example, the weather data may be obtained by retrieving the weather data from the WDS. In one example, DB(s) 136 may receive and store weather data from multiple third-parties. In still another example, one of endpoint devices 111-113 or 121-123 may represent a server of a traffic management service and may forward various traffic related data to DB(s) 136, such as toll payment data, records of traffic volume estimates, traffic signal timing information, and so forth. Similarly, one of endpoint devices 111-113 or 121-123 may represent a server of a consumer credit entity (e.g., a credit bureau, a credit card company, etc.), a merchant, or the like. In such an example, DB(s) 136 may obtain one or more data sets/data feeds comprising information such as: consumer credit scores, credit reports, purchasing information and/or credit card payment information, credit card usage location information, and so forth.

In one example, DB(s) 136 may also store machine learning models (MLMs) that may be activated/deployed by server(s) 135 to operate in parallel with respect to one or more tasks regarding one or more data sets, or data streams. In one example, server(s) 135 and/or DB(s) 136 may comprise cloud-based and/or distributed data storage and/or processing systems comprising one or more servers at a same location or at different locations. For instance, DB(s) 136, or DB(s) 136 in conjunction with one or more of the servers 135, may represent a distributed file system, e.g., a Hadoop® Distributed File System (HDFS™), or the like.

In one example, one or more of servers 135 may comprise a processing system that is configured to perform operations for providing selected results from an application of at least one data set to a plurality of trained machine learning models, as described herein. To illustrate, in one example, server(s) 135 may provide a fraud mitigation service that employs one or more MLMs. For instance, the one or more MLMs may be for providing a fraud alert (e.g., if a likelihood of fraud is calculated to be over a threshold) and/or providing a fraud score (e.g., an indication of how likely the input data evidences fraud). In accordance with the present disclosure, the server(s) 135 may operate a plurality of MLMs in parallel, and may automatically select or may permit a user to select a primary MLM to provide a final result/output, may automatically select or may permit a user to select two or more of the MLMs for generating a composite score as a final result/output, may automatically select or may permit a user to select the output(s)/result(s) of one or more of the MLMs to be used for verification and/or confidence scoring of the output(s)/result(s) of a primary MLM or a set of primary MLMs that are used for providing a composite score, and so forth. In one example, user selection(s) of a primary MLM or other arrangements, such as aggregations of MLMs and/or their results for aggregate scoring, may be provided via one or more of devices 131-134. For instance, devices 131-134 may be associated with personnel that are responsible for fraud monitoring, detection, and mitigation for a telecommunication service provider or other entity.

The MLMs may be generated and trained in accordance with any machine learning algorithms (MLAs) and in accordance with any of the data sets (which may include data feeds/data streams) of any data set owners, e.g., weather data, traffic data, financial/payment data, communication network management and performance data, etc. In general, each MLM may represent a unique combination of MLM/MLA type, MLM/MLA configuration parameters, and a set of one or more data sets. For instance, a first MLM may be a distributed random forest MLM. A second MLM may be a gradient boosting MLM. A third MLM may be a distributed random forest MLM but with different configuration parameters from the first MLM (e.g., 150 trees as compared to 50 trees, etc.). A fourth MLM may be a distributed random forest MLM with the same configuration parameters as the first distributed random forest MLM, but one that is trained with a different set of one or more data sets (and which therefore expects a different set of data set(s) at runtime). For example, the first MLM may be trained on and utilize data set A as input, while the fourth MLM may be trained on and utilize data sets A and B as inputs, and so forth.

In the present example, each of the MLMs may generate an output/result comprising a metric of a likelihood of fraud, e.g., a percent score, where 90 indicates a 90% likelihood of fraud, 80 indicates an 80% likelihood of fraud, etc. For instance, one or more set(s) of data pertaining to a user, customer, transaction, etc. may be input in parallel to multiple MLMs, and each of the MLMs may be applied to the respective data set(s) to output respective fraud scores.

As noted above, different MLMs may be trained on the same data set(s) and may operate on the same data set(s), or may be trained and operate on different combinations of data set(s). In this regard, in one example, the present disclosure utilizes a data streaming platform for distributing various data sets to respective MLMs. For instance, Apache Kafka is a streaming platform that enables applications to stream messages to “topics”. Topics in Kafka are message queues where each message being published to the topic is published to all the applications that are subscribed to the topic. These publishers act as producers, and the subscribers are consumers. Such producers and consumers may be arranged to build complex real-time streaming data pipeline architectures. Kafka allows the messages in a topic to distributed or duplicated across consumers. If the consumers belong to the same consumer group then the messages are distributed across the different consumers in the consumer group; if the consumers belong to different consumer groups then the Kafka messages are duplicated across the different consumers. This duplication property of Kafka for consumers may form the basis of duplication of input data across different models. It should be noted that examples of the present disclosure may utilize other streaming platforms of the same or a similar nature to distribute input data sets to the MLMs operating on server(s) 135. In one example, the data sets distributed in accordance with the data streaming platform may be received by server(s) 135 (or the MLMs operating thereon) directly from the data sources, such as any one or more of devices 111-113 or 121-123, centralized system components of server(s) 155, etc.

Alternatively, or in addition, input data sets for the MLMs may be stored by DB(s) 136 and distributed to the server(s) 135 (or the MLMs operating thereon) in accordance with such a data streaming platform.

Continuing with the present example, the MLMs may operate on respective sets of input data to generate results, e.g., respective fraud scores. In one example, the server(s) 135 may store the results from each MLM in an aggregated results database (e.g., in one or more of DB(s) 136), which may be used to allow inspection by various users, to track accuracy of the respective models in accordance with feedback (for instance, users may confirm whether certain situations were determined to actually constitute fraud, where the output predictions may then be labeled as correct or incorrect (e.g., if the output of an MLM was a fraud score of 50 or greater (e.g., greater than 50 percent likelihood of constituting fraud) and there is a confirmation that the circumstances did in fact involve fraud, this particular prediction may be labeled as correct)), and so forth. On the other hand, if the output of an MLM was a fraud score of 90 and a responsible user later provides an indication that there was no fraud, this particular prediction may be labeled as incorrect. Aggregated over a number of predictions/results, the server(s) 135 may build metrics regarding the respective accuracies of the different MLMs. In one example, the accuracy metrics may comprise moving averages, weighted moving averages, etc.

In addition to storing the results from each of the MLMs, the server(s) 135 may also provide final results of one or more MLMs running in parallel in several ways. For instance, the server(s) 135 may generate an alert of possible fraud if a fraud score output of the final results exceeds a threshold (e.g., greater than 60 percent likelihood of fraud, greater than 70 percent, etc.). The server(s) 135 may also aggregate/correlate results from different MLMs to generate a final output comprising a correlated result. An alert may similarly be generated if the correlated result indicates that a likelihood of fraud exceeds a threshold. The alert may be sent from server(s) 135 to one or more devices of one or more users who are responsible for fraud detection and mitigation, such as any one or more of devices 131-134, one or more of endpoint devices 111-113 and/or endpoint devices 121-123, etc. Alternatively, or in addition, the server(s) 135 may submit the final output/results to one or more other consuming applications. For instance, a network operator or other organization utilizing server(s) 135 for fraud monitoring may configure the server(s) 135 to provide results to an application that tracks levels of fraud by location and that may provide a heat map to devices of one or more monitoring users to provide a visual indication of location-based levels of fraud (e.g., more suspected fraud is currently occurring in Pennsylvania versus Colorado, etc.).

Additional operations of server(s) 135 for providing selected results from an application of at least one data set to a plurality of trained machine learning models, and/or server(s) 135 in conjunction with one or more other devices or systems (such as DB(s) 136) are further described below in connection with the example of FIG. 2. In addition, it should be realized that the system 100 may be implemented in a different form than that illustrated in FIG. 1, or may be expanded by including additional endpoint devices, access networks, network elements, application servers, etc. without altering the scope of the present disclosure. As just one example, any one or more of server(s) 135 and DB(s) 136 may be distributed at different locations, such as in or connected to access networks 110 and 120, in another service network connected to Internet 160 (e.g., a cloud computing provider), in telecommunication service provider network 150, and so forth. Thus, these and other modifications are all contemplated within the scope of the present disclosure.

FIG. 2 illustrates an example process 200 for providing selected results from an application of at least one data set to a plurality of trained machine learning models, in accordance with the present disclosure. In one example, the process 200 may be performed via a processing system comprising one or more physical devices and/or components thereof, such as a server or a plurality of servers, a database system, and so forth. For instance, as shown in FIG. 2, the process 200 may include a data distribution platform 205 for obtaining sets/streams of input data, or input data sets, A-D. The data distribution platform 205 may comprise Apache Kafka, or the like. The data distribution platform 205 may forward different combinations of data sets/streams A-D to different machine learning models (MLMs) of a set of MLMs 210 that are operating in parallel. In one example, the selections of different sets of data streams to different MLMs may be manually or automatically selected in accordance with an application programming interface (API) 290 for interacting with the data distribution platform 205.

The MLMs 1-4 in the set of MLMs 210 may process the respective data set(s) A-D in accordance with the respective configurations of such MLMs, and provide respective outputs to an aggregated results database 220. It should be noted that although the parallel operations of the MLMs 1-4 may be applied to different sets of input data, the data that is processed may all relate to a same “run” or “batch,” e.g., parallel processing by the different MLMs in accordance with data that is relevant to a same customer, a same device, a same transaction or interaction, etc., such as: a customer visit to a retail location, a customer call to an IVR system, a customer call handled by a customer service agent, a customer session with an online customer service system, a customer session with an online account system, a same device, phone number, IP address, etc. that is used to communicate with agents or systems of an organization, and so forth. For instance, with respect to a fraud score process, data set A may include records regarding a particular in-person customer interaction at a retail location of a merchant that involves a specific customer, data set B may comprise credit card usage records regarding the customer, data set C may comprise an account history of the customer with the merchant, data set D may comprise mobile device location information of the customer, and so forth. It should also be noted that although FIG. 2 illustrates an example where each of the MLMs 1-4 of the set of MLMs 210 operates on different sets of input data, in other examples, any two or more, or all of the MLMs 1-4 may operate on the same set(s) of input data.

In one example, the aggregated results database 220 may be organized into a number of records, where each record may include the outputs of the respective MLMs, e.g., for a given run/batch. For instance, record 1 indicates that for a first run, the result/output of MLM 1 is 80% and the result/output of MLM 2 is 90%. Similarly, record 2 indicates that for a second run, the result/output of MLM 1 is 85% and the result/output of MLM 2 is 72%. Records 3 and 4 illustrate additional results for a third and fourth run, respectively. It should be noted that for ease of illustration, the results/outputs of MLMs 3 and 4 are omitted from Records 1-4 as shown in FIG. 2; however, it should be understood that the Records 1-4 may also include these results/outputs.

In addition to storing the results for each MLM for each run, the process 200 may also include generating and providing a final output/result. For instance, the final results 280 may indicate a final output comprising fraud scores generated by MLM 2 for the first through fourth runs. In one example, one or more of the MLM results may be selected for the final results 280 in accordance with a selection entered via an API for result/output selection 295. For instance, in one example, the API for result/output selection 295 may permit a user to manually configure an order of priority of MLMs (e.g., where the MLM with the highest priority is selected as the “primary” MLM to use for the final results 280—in this case MLM 2). For example, a user may rely upon any number of factors to select a primary MLM, such as an accuracy of each of MLMs 1-4, a runtime, an average runtime, a runtime moving average or weighted moving average, a cost of deployment, an average processor utilization and/or memory utilization for each of MLMs 1-4, and so on.

Alternatively, or in addition, the API for result/output selection 295 may provide for an automatic selection of the MLM to use for providing the final results 280. For instance, MLM 2 may be automatically selected in accordance with one or more criteria, such as the accuracy, which may be greater for MLM 2 than for MLM 1, MLM 3, MLM 4, etc. In other words, in one example, the final results 280 may represent the output/results when MLM 2 is automatically selected to be a “primary” MLM. In other examples, the automatic selection criteria may include different factor(s) or additional factor(s), such as a runtime to complete a run, an average runtime over a number of runs within a sliding window, a runtime weighted average or weighted moving average, a cost to deploy a respective MLM, and so forth.

In still another example, the API for result/output selection 295 may provide for an automatic or manual selection of a plurality of MLMs for outputting a correlated result. For instance, for a first run, a user may specify that a correlated result is desired with a weighting of 1 to 1 for MLM 1 and MLM 2. This example is reflected in record 1, which indicates weights (“W”) of 1 and 1. Continuing with the present example, for a second run, the user may specify that a correlated result is desired with a weighting of 0.5 to 0.5 for MLM 1 and MLM 2. This example is reflected in record 2, which indicates weights W of 0.5 and 0.5. Similarly, for a third run, the user may specify that a correlated result is desired with a weighting of 0.2 to 0.5 for MLM 1 and MLM 2. This example is reflected in record 3, which indicates weights W of 0.2 and 0.5. Similarly, in accordance with a user selection, record 4 may indicate weights W of 1 and 0.5 for MLM 1 and MLM 2 respectively. The corresponding correlated results may then be calculated based upon the individual results/outputs of MLM 1 and MLM 2 and the associated weights. For instance, the final results 285 may reflect these calculated correlated results for each of four runs (associated with Records 1-4, respectively). It should be noted that although the illustration of FIG. 2 shows that the combination of weights may be changed for each run (reflected in the different weights in each of Records 1-4), it is not necessarily the case that the weightings will change for each run. For instance, a user (or the processing system in an automated manner) may select a plurality of MLMs and the respective weights to apply to the individual MLM outputs, and may allow this configuration to be utilized for a number of runs, e.g., over the course of minutes, hours, days, etc.

It should also be noted that in one example, a processing system performing the process 200 may be configured to engage in automatic selection of output(s) unless and until a manual selection is made, which may override any automated selection. In addition, it should be noted that the present architecture is designed to allow for the deployment of new MLMs (e.g., after training offline) into a production environment (e.g., into the set of MLMs 210) without disrupting the continued operation of already deployed MLMs operating in parallel. The present architecture also allows for the removal of MLMs from the set of MLMs 210 without disrupting the continued operation of others of the MLMs, and so forth. In this regard, FIG. 2 further illustrates an API for MLM management 292. Via this API, a user or an AI component of the processing system may select which MLMs are to be actively operated in the set of MLMs 210, which MLMs are to be deactivated/removed, and so forth. For example, application binaries for each of the MLMs 1-4 may have been provided via the API for MLM management 292 and then deployed in the set of MLMs 210.

As described above, the process 200 may be performed via a processing system comprising one or more physical devices and/or components thereof, such as a server or a plurality of servers, a database system, and so forth. In this regard, it should be noted that in one example, the data distribution platform 205, the set of MLMs 210, and the aggregated results database 220 may comprise separate physical devices or components installed and/or in operation on separate physical devices. However, in another example, any two or more, or all of the components illustrated in FIG. 2 may be hosted by, installed on, and/or in operation on a same physical device or a shared physical distributed computing platform. For instance, data distribution platform 205 and aggregated results database 220 may comprise one or more of DB(s) 136 of FIG. 1, while the set of MLMs 210 may be in operation on one or more of server(s) 135, and so forth.

FIG. 3 illustrates an example flowchart of a method 300 for providing selected results from an application of at least one data set to a plurality of trained machine learning models. In one example, steps, functions, and/or operations of the method 300 may be performed by a device as illustrated in FIG. 1, e.g., one of servers 135. Alternatively, or in addition, the steps, functions and/or operations of the method 300 may be performed by a processing system collectively comprising a plurality of devices as illustrated in FIG. 1 such as one or more of server(s) 135, DB(s) 136, endpoint devices 111-113 and/or 121-123, devices 131-134, and so forth. In one example, the steps, functions, or operations of method 300 may be performed by a computing device or processing system, such as computing system 400 and/or a hardware processor element 402 as described in connection with FIG. 4 below. For instance, the computing system 400 may represent at least a portion of a platform, a server, a system, and so forth, in accordance with the present disclosure. In one example, the steps, functions, or operations of method 300 may be performed by a processing system comprising a plurality of such computing devices as represented by the computing system 400. For illustrative purposes, the method 300 is described in greater detail below in connection with an example performed by a processing system. The method 300 begins in step 305 and proceeds to step 310.

At step 310, the processing system obtains at least one of a first machine learning model (MLM) or a second machine learning model (MLM). The first MLM and the second MLM each comprise one of a distributed random forest machine learning model, a gradient boosting machine learning model, a deep learning machine learning model, and so forth. In one example, the first MLM and the second MLM may be of a same model type (e.g., which have different configuration parameters and/or which have been trained with different training data sets). In another example, the first MLM and the second MLM may be of different model types (e.g., having been trained with the same or different training data sets).

At step 315, the processing system deploys the at least one of the first MLM or the second MLM to a plurality of trained MLMs for operating in parallel with respect to a same prediction task (e.g., wherein the same prediction task comprises generating at least a first result and a second result in accordance with at least one data set). For instance, the prediction task may be to generate a fraud score based upon one or more data sets. In one example, the plurality of MLMs may be deployed and in operation in a production environment. In other words, the MLMs have been trained and are used for parallel predictions in accordance with a prediction task. Thus, in one example, the at least one of the first MLM or the second MLM may be added to at least one other MLM that may already be deployed and in operation. In one example, both the first MLM and second MLM may be deployed to the plurality of trained MLMs at step 315. In another example, one of the first MLM or the second MLM may be deployed to the plurality of trained MLMs at step 315, while the other of the first MLM or the second MLM may already be one of the plurality of trained MLMs operating in parallel.

In one example, at step 315 the processing system may also receive a selection from a user of a primary MLM to use in generating a final output based upon the result of the primary MLM. In another example, the processing system may receive a selection of one or more MLMs to use in generating a final output comprising a composite of several MLM results.

At step 320, the processing system obtains the at least one data set. In one example, the at least one data set may comprise at least a first data set and at least a second data set. For instance, in an example where the prediction task is to generate a fraud score, the at least one data set (e.g., at least the first data set) may comprise at least one record of at least one customer interaction with at least one of: a customer service representative, a salesperson, an IVR system, an online automated ordering system, or an online subscriber account system. For instance, in one example, the operations of the method 300 may relate to a fraud score process. In addition, in one example, the at least one data set (e.g., at least the second data set) may include at least one record from a data source providing at least one of: user location information, user credit card usage information, user credit history information, or user residence information. The data sets may be obtained from any number of data sources of a single entity or of multiple entities (e.g., subscriber records from a telecommunication network service provider, credit card usage information from a credit card service provider, etc.).

At step 325, the processing system applies the at least one data set to the plurality of trained MLMs, including at least the first MLM and the second MLM. In one example, step 325 may include distributing the at least one data set to at least one of the first MLM or the second MLM. In addition, in one example, the distribution may include publishing the at least one data set to a topic, wherein the at least one of the first MLM or the second MLM comprises at least one subscriber to the topic. It should be noted that the at least one data set may comprise at least a first data set and at least a second data set, where the at least the first data set is applied to at least the first MLM, and where the at least the second data set is applied to at least the second MLM. To illustrate, the first MLM may be configured to process a first set/group of data sets comprising at least the first data set, and the second MLM may be configured to process a second set/group of data sets comprising at least the second data set. In other words, the first MLM and the second MLM may operate on the same data set(s), or may operate on different sets/groups of data sets which may be non-overlapping or partially overlapping.

At step 330, the processing system obtains a first result of the first MLM and a second result of the second MLM in accordance with the applying of step 325. In one example, the first result comprises a first fraud score and the second result comprises a second fraud score. However, in another example, the results may be of a different nature for a different type of prediction task, such as: a prediction of a network failure, where at least the first data set includes network operational data of a telecommunication network, or a prediction of a likelihood of a particular weather event at a given time and at a given location, where at least the first data set includes measurements from one or more weather sensors (e.g., temperature, wind speed, humidity, etc.), historical meteorological data, and so forth.

At step 335, the processing system stores the first result of the first MLM and the second result of the second MLM. For instance, the results may be stored in a record relating to a run/batch for the same prediction task as performed by the plurality of MLMs operating in parallel.

At optional step 340, the processing system may determine a first accuracy metric for the first result and a second accuracy metric for the second result. For instance, in an example, where the results represent fraud scores, users may confirm whether certain situations were determined to actually constitute fraud, where the results (predictions) may then be labeled as correct or incorrect. Similar accuracy metrics may be obtained with respect to other examples. For instance, an accuracy metric may comprise an indication of whether a weather prediction was correct or incorrect, e.g., via manual feedback from a user or from confirmation via contemporaneous measurements from weather data equipment. To illustrate, if the first result of a first MLM predicted a hurricane was 60 percent likely at a given location at a given time, the non-existence of the predicted hurricane at this location and time may be established by wind sensors detecting wind speeds well below hurricane thresholds at such location and for such time.

It should be noted that in some cases, accuracy metrics may be on a binary scale, e.g., correct/incorrect. However, in other examples, the accuracy metrics may be of a different nature. For instance, if a MLM predicted a 60 percent likelihood of hurricane force winds at a particular location at a particular time, and the actual measured wind-speed is found to be strong, but sub-hurricane level, the accuracy of the prediction may be scaled depending upon the deviation of the predicted wind-speed from the measured wind-speed (e.g., for a prediction of 60% likelihood of sustained winds over 70 miles-per-hour in at least a 10 minute interval on Tuesday afternoon and when an actual measured top sustained wind-speed during this time interval at the location is found to be 60 miles-per-hour, the accuracy metric may be 86 percent).

At optional step 345, the processing system may update a first accuracy score of the first machine learning model in accordance with the first accuracy metric and a second accuracy score of the second machine learning model in accordance with the second accuracy metric. For instance, accuracy metrics for each prediction of each MLM may be obtained as described above in connection with optional step 340. Aggregated over a number of predictions/results, the processing system may build accuracy scores regarding the respective accuracies of the different MLMs. In one example, the accuracy scores may comprise moving averages, weighted moving averages, AUC scores, mean squared errors, root mean squared errors, etc. with respect to the above accuracy metrics.

At optional step 350, the processing system may select at least one of the first result or the second result for generating the output. In one example, the selection may be based upon the first accuracy score and/or the second accuracy score. For instance, in one example, the processing system may select the result from the MLM with the greater accuracy score as the output (e.g., an AUC score, mean squared error or root mean squared error, etc.). In one example, multiple factors may be weighted for automatically selecting the at least one of the first result or the second result for generating the output, such as the AUC score and/or the mean squared error, plus one or more of a runtime, an average runtime, a runtime moving average or weighted moving average, a cost of deployment, an average processor utilization and/or memory utilization, or any other combination of such factors, or different factors of the same or a similar nature (with respect to either or both of the first MLM and the second MLM). In one example, the selection may be based upon a user input, where a user may select the at least one of the first result or the second result for generating the output (e.g., selecting the first MLM or the second MLM as a primary MLM, or selecting to have a combined output from at least the first MLM and the second MLM) based upon the same or similar criteria as may be automatically applied by the processing system as described above.

At step 355, the processing system provides an output in accordance with at least one of the first result or the second result. In one example, the output may be in accordance with the at least one of the first result or the second result based upon a selection at optional step 350. In another example, the at least one of the first result or the second result may be designated for generating the output by a user of the processing system. The output may comprise, for example: the first result, the second result, an average of at least the first result and the second result, a weighted average of at least the first result and the second result, etc. Again, it should be noted that the composition of the output (and the generation of the output) may be selected automatically by the processing system via optional step 350 or may be selected by a user.

In one example, the output may be provided to a fraud monitoring application. For instance, the fraud monitoring application may plot a heat map of suspected fraud activity, may generate alerts or reports for further reference, and so forth. In another example, the plurality of MLMs operating in parallel for the same prediction task may be part of a machine learning pipeline, and may provide the output to another stage comprising one or more additional MLMs for further data processing. For instance, fraud scores for multiple parallel runs may be aggregated and may comprise an input to one or more additional MLMs for additional prediction tasks, e.g., predicting a next fraud hotspot, etc. In another example, the output may alternatively or additionally be provided to one or more user devices (e.g., a workstation of fraud monitoring personnel, network operations personnel, personnel of a weather forecasting service, etc.).

Following step 355, the method 300 ends in step 395. It should be noted that method 300 may be expanded to include additional steps, or may be modified to replace steps with different steps, to combine steps, to omit steps, to perform steps in a different order, and so forth. For instance, in one example, the processing system may repeat one or more steps of the method 300, such as steps 310-355 for additional prediction tasks, e.g., for additional parallel “runs,” and so on. For example, each run may be for generating an output comprising a predicted fraud score with regard to a particular transaction, event, user, etc. based upon the at least one data set. In another example, the method 300 may include generating the output, e.g., where the output is selected to comprise an average of two or more MLM results, a weighted average, etc. In still another example, the method 300 may include additional steps of selecting MLMs for inclusion or exclusion from the plurality of MLMs that are operating in parallel for the same prediction task. For instance, the processing system may select to keep in parallel operation the top four MLMs in terms of prediction accuracy over the last week, while other MLMs may be excluded and flagged for evaluation as to whether such MLM(s) should be retained for possible future use, retraining, reconfiguration, etc. For instance, the processing system may attempt to reintroduce such MLMs at a later time to see if performance is better with regard to changing data patterns. Alternatively, or in addition, MLMs having accuracies below a threshold, e.g., consistently less than 50 percent accuracy, less than 75 percent accuracy, etc. may be removed from operation, regardless of whether other alternative MLMs are available to take the place of the removed MLM(s). Thus, these and other modifications are all contemplated within the scope of the present disclosure.

In addition, although not specifically specified, one or more steps, functions, or operations of the method 300 may include a storing, displaying, and/or outputting step as required for a particular application. In other words, any data, records, fields, and/or intermediate results discussed in the method 300 can be stored, displayed and/or outputted either on the device(s) executing the method 300, or to another device or devices, as required for a particular application. Furthermore, steps, blocks, functions, or operations in FIG. 3 that recite a determining operation or involve a decision do not necessarily require that both branches of the determining operation be practiced. In other words, one of the branches of the determining operation can be deemed as an optional step. In addition, one or more steps, blocks, functions, or operations of the above described method 300 may comprise optional steps, or can be combined, separated, and/or performed in a different order from that described above, without departing from the examples of the present disclosure.

FIG. 4 depicts a high-level block diagram of a computing system 400 (e.g., a computing device, or processing system) specifically programmed to perform the functions described herein. For example, any one or more components or devices illustrated in FIG. 1, or described in connection with the process 200 of FIG. 2 or the method 300 of FIG. 3 may be implemented as the computing system 400. As depicted in FIG. 4, the computing system 400 comprises a hardware processor element 402 (e.g., comprising one or more hardware processors, which may include one or more microprocessor(s), one or more central processing units (CPUs), and/or the like, where hardware processor element may also represent one example of a “processing system” as referred to herein), a memory 404, (e.g., random access memory (RAM), read only memory (ROM), a disk drive, an optical drive, a magnetic drive, and/or a Universal Serial Bus (USB) drive), a module 405 for providing selected results from an application of at least one data set to a plurality of trained machine learning models, and various input/output devices 406, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one hardware processor element 402 is shown, it should be noted that the computing device may employ a plurality of hardware processor elements. Furthermore, although only one computing device is shown in FIG. 4, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of FIG. 4 is intended to represent each of those multiple computing devices. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor element 402 can also be configured or programmed to cause other devices to perform one or more operations as discussed above. In other words, the hardware processor element 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for providing selected results from an application of at least one data set to a plurality of trained machine learning models (e.g., a software program comprising computer-executable instructions) can be loaded into memory 404 and executed by hardware processor element 402 to implement the steps, functions or operations as discussed above in connection with the example method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for providing selected results from an application of at least one data set to a plurality of trained machine learning models (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
obtaining, by a processing system including at least one processor, at least one of a first machine learning model or a second machine learning model;
deploying, by the processing system, the at least one of the first machine learning model or the second machine learning model to a plurality of trained machine learning models for operating in parallel with respect to a same prediction task, wherein the plurality of trained machine learning models includes at least the first machine learning model and the second machine learning model in accordance with the deploying, wherein the same prediction task comprises generating at least a first result of the first machine learning model and a second result of the second machine learning model in accordance with at least one data set;
obtaining, by the processing system, the at least one data set;
applying, by the processing system, the at least one data set to the plurality of trained machine learning models;
obtaining, by the processing system, the first result of the first machine learning model and the second result of the second machine learning model in accordance with the applying;
storing, by the processing system, the first result of the first machine learning model and the second result of the second machine learning model; and
providing, by the processing system, an output in accordance with at least one of the first result or the second result.

2. The method of claim 1, wherein the at least one of the first result or the second result is designated for generating the output by a user of the processing system.

3. The method of claim 1, further comprising:
selecting, by the processing system, the at least one of the first result or the second result for generating the output.

4. The method of claim 3, further comprising:
determining a first accuracy metric for the first result and a second accuracy metric for the second result; and
updating a first accuracy score of the first machine learning model in accordance with the first accuracy metric and a second accuracy score of the second machine learning model in accordance with the second accuracy metric.

5. The method of claim 4, wherein the selecting the at least one of the first result or the second result for generating the output is based upon at least one of the first accuracy score or the second accuracy score.

6. The method of claim 1, wherein the output comprises:
the first result;
the second result;
an average of at least the first result and the second result; or
a weighted average of at least the first result and the second result.

7. The method of claim 1, wherein the applying the at least one data set to the plurality of trained machine learning models comprises:
distributing the at least one data set to at least one of the first machine learning model or the second machine learning model.

8. The method of claim 7, wherein the distributing comprises:
publishing the at least one data set to a topic, wherein the at least one of the first machine learning model or the second machine learning model comprises at least one subscriber to the topic.

9. The method of claim 1, wherein the at least one data set comprises at least a first data set and at least a second data set.

10. The method of claim 9, wherein the at least the first data set is applied to at least the first machine learning model, and wherein the at least the second data set is applied to at least the second machine learning model.

11. The method of claim 10, wherein the first machine learning model is configured to process a first set of data sets comprising at least the first data set, and wherein the second machine learning model is configured to process a second set of data sets comprising at least the second data set.

12. The method of claim 1, wherein the first machine learning model and the second machine learning model each comprise one of:
a distributed random forest machine learning model;
a gradient boosting machine learning model; or
a deep learning machine learning model.

13. The method of claim 1, wherein the first machine learning model and the second machine learning model comprise a same type of machine learning model with different parameters.

14. The method of claim 1, wherein the first machine learning model and the second machine learning model comprise a same type of machine learning model with same parameters, wherein the first machine learning model and the second machine learning model are configured with different training data.

15. The method of claim 1, wherein the first result comprises a first fraud score and the second result comprises a second fraud score.

16. The method of claim 15, wherein the output is provided to a fraud monitoring application.

17. The method of claim 1, wherein the at least one data set comprises at least a first data set and at least a second data set, wherein the at least the first data set comprises at least one record of at least one customer interaction with at least one of: a customer service representative, a salesperson, an interactive voice response system, an online automated ordering system, or an online subscriber account system.

18. The method of claim 17, wherein the at least the second data set comprises at least one record from a data source providing at least one of: user location information, user credit card usage information, user credit history information, or user residence information.

19. A non-transitory computer-readable medium storing instructions which, when executed by a processing system including at least one processor, cause the processing system to perform operations, the operations comprising:
obtaining at least one of a first machine learning model or a second machine learning model;
deploying the at least one of the first machine learning model or the second machine learning model to a plurality of trained machine learning models for operating in parallel with respect to a same prediction task, wherein the plurality of trained machine learning models includes at least the first machine learning model and the second machine learning model in accordance with the deploying, wherein the same prediction task comprises generating at least a first result of the first machine learning model and a second result of the second machine learning model in accordance with at least one data set;
obtaining the at least one data set;
applying the at least one data set to the plurality of trained machine learning models;
obtaining the first result of the first machine learning model and the second result of the second machine learning model in accordance with the applying;
storing the first result of the first machine learning model and the second result of the second machine learning model; and
providing an output in accordance with at least one of the first result or the second result.

20. An apparatus comprising:
a processing system including at least one processor; and
a non-transitory computer-readable medium storing instructions which, when executed by the processing system, cause the processing system to perform operations, the operations comprising:
obtaining at least one of a first machine learning model or a second machine learning model;
deploying the at least one of the first machine learning model or the second machine learning model to a plurality of trained machine learning models for operating in parallel with respect to a same prediction task, wherein the plurality of trained machine learning models includes at least the first machine learning model and the second machine learning model in accordance with the deploying, wherein the same prediction task comprises generating at least a first result of the first machine learning model and a second result of the second machine learning model in accordance with at least one data set;
obtaining the at least one data set;
applying the at least one data set to the plurality of trained machine learning models;
obtaining the first result of the first machine learning model and the second result of the second machine learning model in accordance with the applying;
storing the first result of the first machine learning model and the second result of the second machine learning model; and
providing an output in accordance with at least one of the first result or the second result.
